(19) United States
(12) Patent Application Publication
(10) Pub. No.: US 2009/0226797 A1
(43) Pub. Date: Sep. 10, 2009

(54) ELECTRIC STORAGE DEVICE AND ELECTRIC STORAGE SYSTEM

(75) Inventors: Hideya Yoshitake, Tokyo (JP); Kenji Fukuda, Ube (JP); Dai Inamori, Ube (JP); Hirofumi Takemoto, Ube (JP)

Correspondence Address: KNOBBE MARTENS OLSON & BEAR LLP, 2040 MAIN STREET, FOURTEENTH FLOOR, IRVINE, CA, 92614, US

(73) Assignee: Ube Industries, Ltd., Ube (JP)

(21) Appl. No.: 12/301,009

(22) PCT Filed: May 16, 2007
(86) PCT No.: PCT/JP2007/060064

§ 371 Date: Mar. 4, 2009

(30) Foreign Application Priority Data
May 16, 2006 (JP) 2006-136500
Oct. 3, 2006 (JP) 2006-272316

(51) Int. Cl. H01M 10/44; H01M 6/14; H01M 2/00

(52) U.S. Cl. 429/50; 429/188; 429/199; 429/203; 429/61

(57) ABSTRACT

There is provided an electric storage device comprising carbonaceous active material-containing positive and negative electrodes, an onium salt-containing nonaqueous electrolyte, and a separator, wherein an electrochemical charge process in the positive electrode shows a sequential charge process having a threshold of a transition voltage and consisting of an adsorption process of anions of the onium salt in a lower voltage range than the transition voltage and an intercalation process of anions of the onium salt in a higher voltage range than the transition voltage. The electric storage device is advantageous in that the electric storage capacity and energy capacity which can be substantially utilizable are large and, at the same time, a charge/discharge cycle is highly reliable.

### TECHNICAL FIELD

The present invention relates to an electric storage device and an electric storage system with a high voltage operation and a large capacity which is highly reliable in a charge/discharge cycle, as well as an electronic device and a power system therewith.

### BACKGROUND ART

Lithium ion secondary batteries, electric double layer capacitors and the like are known as electric storage devices using a non-aqueous electrolyte.

In a lithium ion secondary battery, a lithium-containing transition metal oxide is used for a positive electrode, a graphite carbon compound into which lithium can be intercalated is used for a negative electrode, and a non-aqueous electrolyte containing a lithium salt is used for an electrolyte.

A lithium ion secondary battery generally uses a lithium-containing transition metal oxide as a positive electrode, so that the lithium ion secondary battery allows for charge/discharge with a high voltage operation and is thus appreciated as a high capacity battery, while positive/negative electrode active materials themselves absorb and release lithium ions, leading to early deterioration in a charge/discharge cycle.

An electric double layer capacitor has a positive electrode and a negative electrode which are polarizable electrodes containing active charcoal as a main component, allowing rapid charge/discharge and ensuring high reliability in a charge/discharge cycle although a capacity is low.

However, there has been demanded an electrochemical system capable of operating at a higher voltage because an electric energy of an electric double layer capacitor that utilizes an electric double layer capacity formed in an interface between a polarizable electrode and an electrolyte and hence forms a stable power source is expressed by ½ CV². Herein, C refers to a capacitance [farad] and V refers to an voltage [volt]

There has been recently suggested a system for improving a capacity in an electric storage system in an electric double layer capacitor, in which a positive electrode includes PFPT (poly-p-fluorophenylthiophene) and a negative electrode includes active charcoal. There have been also suggested a system where a positive electrode includes active charcoal and a negative electrode includes lithium titanate, and a system where a positive electrode includes active charcoal and a negative electrode includes a graphite carbon. For these proposed electric storage systems, there have been, however, reported possibility of deterioration during initial charge/discharge cycles, reduction in a capacity due to rapid charge/discharge and structural deterioration due to repetitive insertion and release of lithium ions to a graphite carbon. For example, Japanese Laid-open Patent Publication No. 1998-199767 (Patent Document 1) has proposed a special carbon material as an electrode material in an electric double layer capacitor and a manufacturing process therefor.

Japanese Laid-open Patent Publication No. 2002-151364 (Patent Document 2) has proposed an electric double layer capacitor comprising a graphite carbon material having a FWHM (full width at half maximum) of 0.5 to 5.0° in X-ray diffraction of (002) peak as a main component of both electrodes, a positive electrode and a negative electrode, which is, as illustrated in examples therein, characterized in that an electric double layer capacitor prepared is used after applying a high voltage of 3.8 V for 20 min to 5 hours instead of steam activation.

Japanese Laid-open Patent Publication No. 2004-134658 (Patent Document 3) has proposed an electric double layer capacitor where a carbon material for a positive electrode is a boron-containing graphite prepared by heating a carbon material containing boron or a boron compound and a carbon material for a negative electrode is active charcoal. Although assuming an intercalation reaction of anions in a positive electrode, Japanese Laid-open Patent Publication No. 2004-134658 (Patent Document 3) has not demonstrated details of a charge/discharge process. Furthermore, the document has not demonstrated details in terms of physical properties such as a specific surface area for boron-containing graphite.

Japanese Laid-open Patent Publication No. 2005-294780 (Patent Document 4) has proposed an electric double layer capacitor employing a graphite as a positive active material and a graphite or active charcoal as a negative active material, and has described that a capacitor capacity is generated by adsorption/desorption of ions in the positive and the negative electrodes.

Patent document 1: Japanese Laid-open Patent Publication No. 1998-199767

Patent document 2: Japanese Laid-open Patent Publication No. 2002-151364

Patent document 3: Japanese Laid-open Patent Publication No. 2004-134658

Patent document 4: Japanese Laid-open Patent Publication No. 2005-294780

### DISCLOSURE OF THE INVENTION

### Problems to be Solved by the Invention

As described above, there have been proposed non-aqueous electric double layer capacitors employing graphite or active charcoal as a positive electrode, but they have an inadequate electric storage capacity or energy capacity for practical use and a charge/discharge process is not properly controlled to achieve satisfactory cycle properties.

An objective of the present invention is to provide an electric storage device having an electric storage capacity and an energy capacity sufficient for practical use and exhibiting highly reliable charge/discharge cycle, which can be used in place of a conventional lead battery, lithium-ion secondary battery, nickel-metal-hydride secondary battery, electric double layer capacitor or the like.

### Means to solve the Problems

The present invention relates to the following items.

1. An electric storage device comprising carbonaceous active material-containing positive electrode and negative electrode, an onium salt-containing nonaqueous electrolyte, and a separator,

wherein an electrochemical charge process in the positive electrode shows a two-step sequential charge process having a threshold of a transition voltage and consisting of an adsorption process of anions of the onium salt in a lower voltage range and an intercalation process of anions of the onium salt in a higher voltage range.

2. The electric storage device according to the above item 1, wherein only a voltage range where anions of the onium salt intercalate is used as a charge/discharge range during operation.

3. The electric storage device according to the above item 1 or 2, wherein the transition voltage is set within the range of 1.5 to 2.5 V.

4. The electric storage device according to any of the above items 1 to 3, wherein

the positive active material is a graphitic material, and

the negative active material is a carbonaceous material having a larger specific surface area than that of the graphitic material used as the positive active material.

5. The electric storage device according to the above item 4, wherein the graphitic material used as the positive active material has a d(002) interlayer distance of 0.340 nm or less and a specific surface area of less than 10 m²/g.

6. The electric storage device according to the above item 5 wherein the graphitic material used as the positive active material does not comprise a rhombohedron structure.

7. The electric storage device according to any of the above items 1 to 6, wherein anions of the onium salt contain at least one of PF₆_{^{−}} and BF₄_{^{−}}.

8. An electric storage system comprising the electric storage device according to any of the above items 1 to 7, using only a voltage range where anions of the onium salt intercalate.

9. The electric storage system according to the above item 8, comprising a voltage controlling mechanism which controls a voltage during operation within only a voltage range where anions of the onium salt intercalate.

10. An electric storage system comprising the electric storage device according to any of the above items 1 to 7, wherein

the positive active material is a graphitic material, and

during charging in the operation as an electric storage device, a charging voltage is controlled such that a positive electrode capacity is within the range of 47 mAh/g to 31 mAh/g and an interlayer distance in the graphitic material is within the range of 0.434 nm to 0.337 nm.

11. An electric storage system, according to the above item 10 or comprising the electric storage device according to any of the above items 1 to 7, wherein in the operation as an electric storage device, a positive electrode potential to a Li_{⁺}/Li electrode during charging is controlled to be 5.2 V or less.

12. An electric storage system, according to claim 10 or 11, or comprising the electric storage device according to any of the above items 1 to 7, wherein in the operation as an electric storage device, the system is used with a charging voltage of 3.2 V or less.

13. The electric storage system according to any of the above items 10 to 12, wherein an interlayer distance of the graphitic material before charging is 0.336 nm or less.

14. The electric storage system according to any of the above items 10 to 13, wherein in a charging curve between 1.8 V and 3 V, a capacitance of the graphitic material is 390 F/g or more.

15. An electronic device comprising the electric storage device according to any of the above items 1 to 7 or the electric storage system according to any of the above items 8 to 14.

16. A motive power system comprising the electric storage device according to any of the above items 1 to 7 or the electric storage system according to any of the above items 8 to 14.

17. A method for controlling a voltage initiating decomposition of the electrolyte in the electric storage device according to any of the above items 1 to 7, wherein the decomposition initiating voltage is controlled by changing the transition voltage.

### EFFECT OF THE INVENTION

According to the present invention, there can be provided an electric storage device which can be used at a higher voltage than a conventional electric double layer capacitor, exhibits a larger substantially-available electric storage capacity and energy capacity and provides a highly reliable charge/discharge cycle, while maintaining high-speed charge/discharge which is a characteristic property in a non-aqueous electric double layer capacitor.

In an electric storage device of the present invention, a charge/discharge process is a two-step process consisting of reversible adsorption and reversible intercalation of anions into a positive electrode active material, so that there can be provided an electric storage device with a high capacity, particularly a high energy capacity utilizing an intercalation range, while inhibiting a decomposition reaction of an electrolyte. An electric storage device of the present invention does not belong to the category of an electric double layer capacitor demonstrating a capacity by adsorption of an electrolyte in a polarizable electrode, but can achieve charge/discharge at a higher speed in comparison with a conventional battery.

### BRIEF DESCRIPTION OF THE DRAWINGS

FIG. 1A is a graph (chronopotentiogram) showing a relationship between a charge/discharge capacity and a voltage in an electric storage device of the present invention.

FIG. 1B is a graph (chronopotentiogram) showing a relationship between a charge/discharge capacity and a voltage in a conventional electric double layer capacitor.

FIG. 2 is a graph (chronopotentiogram) showing a relationship between a charge/discharge capacity and a voltage in Example 1.

FIG. 3 is a graph in which a charge/discharge capacity differentiated with respect to a voltage is plotted to a voltage on the basis of the chronopotentiogram of Example 1.

FIG. 4 shows X-ray diffraction patterns determined at each voltage during charging of the device in Example 1.

FIG. 5 shows X-ray diffraction patterns determined at each voltage during discharging of the device in Example 1.

FIG. 6 is a graph (chronopotentiogram) showing a relationship between a charge/discharge capacity and a voltage in Example 2.

FIG. 7 is a graph in which a charge/discharge capacity differentiated with respect to a voltage is plotted to a voltage on the basis of the chronopotentiogram of Example 2.

FIG. 8 is a graph (chronopotentiogram) showing a relationship between a charge/discharge capacity and a voltage in Reference Example.

FIG. 9 is a cyclic voltammogram of anion intercalation into graphite where Li metal is a counter and reference electrode.

FIG. 10 shows a X-ray diffraction pattern of graphite before charging and after charging 5.2 V to a Li_{⁺}/Li electrode.

FIG. 11 is a graph showing cycle properties.

FIG. 12 is a graph showing voltage change in a positive and a negative electrodes using a three electrode cell.

FIG. 13 is a graph showing voltage change in a positive electrode.

FIG. 14 is a graph showing voltage change in a negative electrode.

### BEST MODE FOR CARRYING OUT THE INVENTION

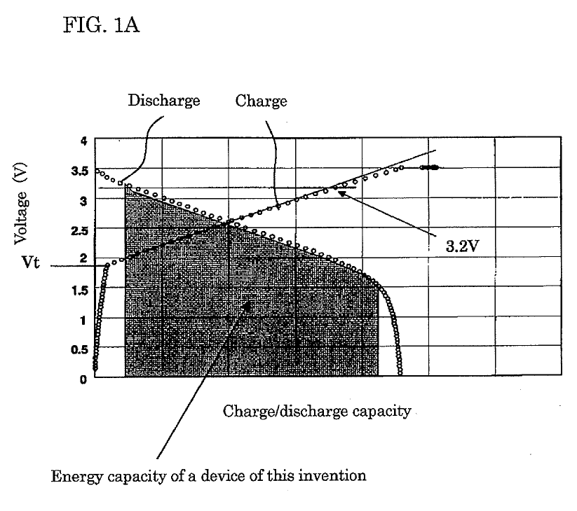

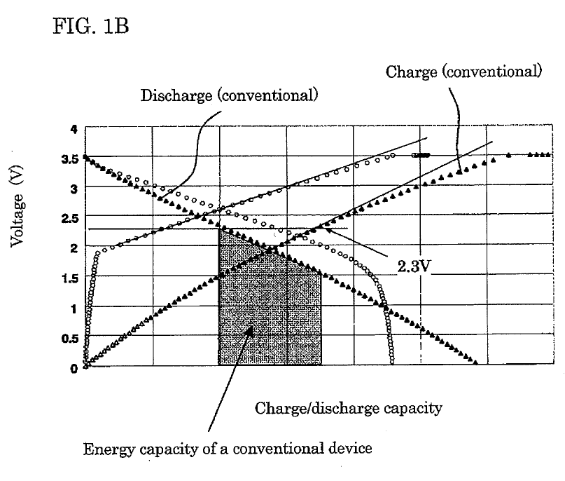

FIG. 1A shows the typical charge/discharge properties of an electric storage device of the present invention. FIG. 1B shows the charge/discharge properties of a conventional device in which active charcoal is used in a positive and a negative electrodes as an electric double layer capacitor together with the properties of the present invention in FIG. 1A. In these graphs of charging capacity-voltage property curve (chronopotentiogram), an abscissa is a charge/discharge capacity while an ordinate is a voltage. For example, assuming that constant current charge is conducted, an abscissa corresponds to a charging time as well as a charging capacity.

In an electric storage device of the present invention, during charging, a slope of a charging capacity-voltage property curve remarkably changes at a voltage Vt, as shown in FIG. 1A. That is, as described in the examples later, anions of an onium salt are adsorbed in a positive electrode active material until the voltage Vt and at the voltage Vt or higher, the anions intercalate into the positive electrode active material. Herein, the voltage Vt at which a charge process changes from adsorption to intercalation is defined as a transition voltage.

In charging by adsorption until the transition voltage Vt, the amount of anions adsorbed by a positive electrode active material having a small specific surface area is small, so that the charging capacity of the device is small and a larger slope is observed in a charging capacity-voltage property curve. In the subsequent charge process by intercalation, voltage variation is relatively small and a larger charge can be incorporated, so that a larger electric storage capacity is attained.

Discussing intercalation in greater details, the process can be divided into a process where anions absorbed in the surface of the positive electrode active material rapidly intercalate at about a transition voltage Vt and a subsequent common regular intercalation process. A reaction current from intercalation of adsorbed anions around the transition voltage Vt is small, but the intercalation occurs within a narrow voltage range, so that when measuring a capacity variation per a unit voltage, a reaction current is detected as a local maximal value or a shoulder in this voltage range. However, when a specific surface area of a graphitic material used in a positive electrode is small, the amount of adsorbed anions involved in intercalation may be too small to be clearly detected as a peak. In a system where this electric storage device is used only in a voltage range higher than the transition voltage, a transition voltage Vt cannot be, of course, apparently observed during the charge/discharge.

During discharge, as the discharge amount increases (reduction of a residual capacity), a voltage gradually reduces by deintercalation, and once most of anions deintercalate, a voltage rapidly reduces. However, unlike charging, the deintercalation process and the desorption process do not appear as a clearly discernable two-step sequential process, and thus a distinct transition voltage is not observed in a chronopotentiogram.

In an electric storage device of the present invention, a charge/discharge range in use is preferably in the state of intercalation. FIG. 1A indicates that during discharge, the range down to 1.5 V, below the transition voltage Vt, is available, but even in this state, intercalating anions remain and thus, when recharging is initiated from this state, the charging is initiated from a voltage higher than the transition voltage Vt without an adsorption process. A difference between the transition voltage Vt during charging and a voltage available in the intercalation state during discharging is also influenced by a value of current during charge/discharge, an internal resistance and the like, and is generally about 0.5 V.

In an electric storage device of the present invention, since discharging proceeds maintaining high voltage described above, it has large practically available electric storage capacity in the voltage range needed in electronic devices. Furthermore, since an available energy capacity corresponds to an integration of a chronopotentiogram, the device of the present invention also has a characteristic of a larger energy capacity due to high-voltage discharge.

On the other hand, more gentle slope is observed in a charge/discharge chronopotentiogram of a conventional electric double layer capacitor using active charcoal for a positive and a negative electrodes as shown in FIG. 1B. This indicates that a charging capacity is large at a low voltage, and thus, in this example, a capacity available within the range below 1.5 V is larger in comparison with an electric storage device of the present invention. However, when an electric storage device is built in an electronic device operating at 1.5 V or higher, the fact that a charging capacity is large in the range of 1.5 V or lower is not significant at all. In other words, an electric storage device of the present invention is characterized in that it has a large charging capacity, particularly a large energy capacity in a relatively higher voltage range which is practically used.

Therefore, a transition voltage Vt in an electric storage device of the present invention is preferably determined, taking a voltage used in an actual electronic device into consideration, and is preferably set to 1.5 V or higher in general.

A transition voltage Vt depends on a capacity of a positive electrode active material and a capacity of a negative electrode active material, particularly on a ratio of these, and therefore, a transition voltage Vt can be controlled by adjusting a combination of these. A large capacity of a positive electrode active material results in a low transition voltage Vt while a large capacity of a negative electrode active material results in a high transition voltage Vt.

Furthermore, in the electric storage device of the present invention, for example, capacities of the positive electrode active material and negative electrode active material can be adjusted, that is, the transition voltage Vt can be adjusted to inhibit a decomposition reaction of the electrolyte in the positive electrode for improving cycle properties during charging (in other words, during intercalation into the positive electrode active material). We have found that in a conventional electric double layer capacitor using graphite in a positive electrode, decomposition of an electrolyte (solvent) occurs on the positive electrode and as a result, an organic substance as a decomposition product moves toward a negative electrode and then coats the surface of the negative electrode, which causes reduction of an effective electric double layer in the surface of the negative electrode after each cycle, leading to reduction in a capacity holding ratio, that is, deterioration in cycle properties. A voltage initiating decomposition of an electrolyte depends on various factors such as the type and a surface area of active charcoal and a capacity ratio of a positive electrode to a negative electrode. An observed decomposition reaction current is about 3.2 V (FIG. 1A) in the electric storage device of the present invention in this example, whereas it is about 2.3 V (FIG. 1B) in a conventional electric double layer capacitor.

As one method for inhibiting decomposition of an electrolyte (solvent) on a positive electrode, it is effective that during charging, a potential in the positive electrode side does not exceed a decomposition potential. In an electric storage device of the present invention, for example, a capacity ratio of a negative electrode to a positive electrode can be increased so as to set a high transition voltage, which allows such a charging that, with the increase of a charging capacity, the increase in the positive electrode potential is small while absolute-value of the negative electrode potential increases to a large value range. As a result, a decomposition voltage as a device voltage increases. Thus, in addition to increase in an available voltage in an electric storage device, the device can be used within a voltage range where a decomposition reaction of the electrolyte is sufficiently inhibited. Deposition of an organic substance over a negative electrode is minimized and thus deterioration in a capacity of the electric storage device is improved, resulting in improved cycle properties.

For improving cycle properties, a transition voltage Vt is preferably set to 1.5 V to 2.5 V, particularly preferably 1.7 V to 2.3 V. If the transition voltage is lower than 1.5 V, an electric storage capacity is large but electrolyte decomposition in a positive electrode cannot be inhibited, leading to tendency to deterioration in cycle properties. If the transition voltage is higher than 2.5 V, electrolyte decomposition in a positive electrode is completely prevented, resulting in improved cycle properties, but an electric storage capacity is small.

Specifically, when a weight ratio of a positive electrode active material to a negative electrode active material is 1/1 in FIGS. 1A and 1B, a discharge capacity of an electric double layer capacitor using active charcoal having a higher surface area of 2200 m²/g or more as an active material in both electrodes from 3.5 V to 0 V is higher than that of an electric storage device of the present invention. However, since a reaction current is observed at 2.3 V during charging, a charging voltage is limited to 2.3 V or lower. On the other hand, charging can be conducted up to about 3.2 V in the electric storage device of the present invention. Therefore, when a practically used voltage range is, for example, 1.5 V or higher, a charge/discharge capacity available in the electric storage device of the present invention is within the range of 3.2 V to 1.5 V, indicating an improved charge/discharge capacity in comparison with that of the electric double layer capacitor which can utilize only the range of 2.3 V to 1.5 V. Furthermore, a discharge energy in the electric storage device of the present invention is three times or more as much as that in the electric double layer capacitor.

As described above, because charging in a positive electrode active material proceeds as a two-step process of adsorption and intercalation, an electric storage device of the present invention can utilize a larger discharge capacity and a larger discharge energy, particularly by setting a relatively higher transition voltage Vt, for example, to the range of 1.5 V to 2.5 V. Furthermore, in the light of decomposition of an electrolyte, the electric storage device of the present invention is extremely excellent in a discharge capacity and a discharge energy available in a practical apparatus as well as cycle properties.

An electric storage device of the present invention can operate even at a high voltage of 3 V or more and can conduct charge/discharge at a high capacity, so that it can charge a higher energy. It can be used in applications such as a back-up power supply in a personal computer, a cell phone, a portable mobile device and a power supply for a digital camera. Furthermore, an electric storage device of the present invention can be applied to a motive power system in a battery car or an HEV.

Particularly, when being used in a power system requiring a high voltage, a discharge voltage in this electric storage device is preferably cut at 1.5 V or higher, desirably 2 V or higher.

Therefore, when being practically used as a device, an electric storage system using an electric storage device of the present invention is preferably used such that the charge/discharge range is limited to the intercalation range. Here, an electric storage system includes, in addition to an electric storage device of the present invention, peripheral members supporting operation of the electric storage device in use, for example, a means for detecting a voltage between a positive and a negative electrodes in the electric storage device. An electric storage system of the present invention preferably contains a known voltage controlling means capable of shutting the system down when a voltage decreases to a predetermined value, in order to limit charge/discharge in the electric storage device to the intercalation range.

Embodiments of an Electric Storage System of this Invention

Next, there will be described embodiments of an electric storage system using an electric storage device of the present invention, particularly those where the conditions, an application method and the like are adjusted such that cycle properties are improved.

In an electric storage system of this embodiment, a positive active material is a graphitic material, a capacity of a positive electrode as an electric storage device is within the range of 47 mAh/g to 31 mAh/g, and during charging when it is used as an electric storage device, a charging voltage is controlled such that an interlayer distance in the graphitic material is within the range of 0.434 nm to 0.337 nm.

An interlayer distance in the graphitic material in the positive electrode varies depending on anion intercalation. Since intercalation/deintercalation associated with charge/discharge is a reversible reaction, an increased graphite interlayer distance due to charge is reduced to an original interlayer distance by discharge. However, when a charging potential is increased and the intercalation amount of anions having a large ion radius are increased, repetition of intercalation and deintercalation causes distortion of graphite, leading to phenomena that anions remaining between layers of graphite increase and that a graphite interlayer distance after discharge does not return to the interlayer distance before charge. According to our investigation, in terms of the stage number of intercalation of anions into between graphite layers, a fourth stage, that is, a stage that there exists one anion-intercalated layer per four graphite graphene layers, is the upper limit where anions can intercalate, maintaining good cycle properties. A potential at the fourth stage is about 5.2 V (with reference to an Li_{⁺}/Li potential) and a theoretical capacity for an anion-intercalated graphite at the fourth stage is 47 mAh/g. Multistage intercalation for graphite has been demonstrated on the basis of intercalation potential measurement by J. A. Seel and J. R. Dahn J. Electrochem. Soc., 147, 899, (2000).

In a structure where intercalation further proceeds (third to first stages), reversible intercalation does not proceed and at the same time, an electrolyte is decomposed, causing gradual capacity deterioration, that is, cycle deterioration. A charging voltage involving the intercalation of the fourth stage in a device of the present invention varies depending on a capacity ratio of a positive electrode to a negative electrode, but is generally about 3.2 V to 3.5 V. By utilizing intercalation and deintercalation in the fourth stage, a positive electrode capacity in an electric storage device of the present invention is controlled to the range of 47 mAh/g to 31 mAh/g.

Increase in a graphite interlayer distance can be confirmed by X-ray diffraction (XRD). When using BF₄_{^{−}} as an anion, an interlayer distance of graphite is increased to 0.434 nm at a charging potential 5.2 V (with reference to an Li_{⁺}/Li potential). In this case, the stage number is 4. Therefore, in terms of a range where good cycle properties can be maintained, a charging voltage is preferably controlled such that in practical use, a device is used with an interlayer distance of a graphitic material of 0.434 nm or less even on a full charge. However, for initiating intercalation, it is necessary to increase an interlayer distance of the graphitic material, so that the device is preferably used, controlling a charging voltage such that the distance is within the range of 0.434 nm to 0.337 nm. Further preferably, in this system, the voltage is controlled such that an interlayer distance is within the range of 0.429 nm to 0.337 nm.

Cycle properties are influenced not only by a distortion of a graphitic material as described above but also a decomposition reaction of an electrolyte, and a potential on a full charge in the positive electrode side in use is also limited by an oxidative-decomposition potential of an electrolyte. Depending on a solvent in an electrolyte, for example, a decomposition reaction may be significantly observed at a charging voltage of 5.5 V (with reference to an Li_{⁺}/Li potential) or higher. A charging voltage is, therefore, preferably 5.5 V (with reference to an Li_{⁺}/Li potential) or lower, more preferably 5.2 V (with reference to an Li_{⁺}/Li potential) or lower. Further preferably, it is 5.0 V (with reference to an Li_{⁺}/Li potential) or lower. These conditions are not limited to this embodiment, but are preferable for other electric storage systems of the present invention. This optimal charging potential can be determined by cyclic voltammetry (CV method) at an Li_{⁺}/Li potential.

An electrolyte is decomposed not only by an oxidative decomposition reaction of the electrolyte in the positive electrode side but also by increase of a potential over a reduction potential of the electrolyte in the negative electrode side. It is necessary to balance a capacity between a positive and a negative electrodes within a potential range where solvent decomposition does not occur. For example, increase in a negative electrode capacity causes increase of a positive electrode potential to form a stage 1 or 2 structure, by which a capacity per a unit weight increases from 186 to 93 mAh/g, but once a ratio of a negative electrode capacity exceeds a certain level in relation to a positive electrode capacity, it causes decomposition of an electrolyte due to increase in a positive electrode potential, leading to substantial deterioration in cycle properties.

Thus, by optimizing the charging voltage and adjusting the capacity balance between a positive and a negative electrode active materials, such a device can be designed that has sufficient device capacity, capability of high-voltage operation and good cycle properties. For example, a charging voltage and a stage number can be set to 3.2 V and 4 or less (that is, stage 4, 5, 6 or the like), respectively, to provide a device having a high capacity, a high voltage and improved cycle properties while maintaining a positive electrode capacity of about 47 mAh/g or less and 31 mAh/g or more. Here, the condition that a charging voltage is 3.2 V or lower is applied not only to this embodiment but also preferably to other electric storage systems of the present invention.

Here, a positive electrode capacity in an electric storage device in use can be controlled by a negative electrode capacity. It is because a cation adsorption capacity in a negative electrode is smaller than an anion intercalation capacity in a positive electrode, so that the actual amount of anion intercalation depends on the amount of cations polarized in the negative electrode side.

When the electric storage system of this embodiment is charged to a level that a positive electrode capacity as an electric storage device is in the range of 47 mAh/g or less and 31 mAh/g or more, a capacity of a negative electrode active material can be selected to give a predetermined inter-terminal voltage between a positive and a negative electrodes (for example, 3.2 V). This allows a charging while maintaining the charging potential in a positive electrode within a preferable range, resulting that a large capacity, a high voltage and improved cycle properties are fulfilled.

Thus, for meeting these conditions, parameters for a positive and a negative electrodes can be determined, for example, as follows.

First, a capacitance of a positive electrode is set. A capacity of a positive electrode independent of a capacity of a negative electrode can be estimated by measuring voltage change when a charge/discharge capacity and a charge/discharge voltage are in linear relationship. When the weights of the positive electrode active material and the negative electrode active material are Wc and Wa, respectively, their capacitances are Fc and Fa, respectively and voltage changes associated with their charging are Vc and Va, respectively, an equation: Wc×Fc×Vc=Wa×Fa×Va is derived. When these measurements are conducted with a three-electrode cell and Wc=Wa is assumed for facilitating comparison of capacities of active materials used in the present invention, generally Vc/Va=⅓ to 1/12. In other words, Fc is about three to twelve times as much as Fa. Since a capacitance of active charcoal used as a negative electrode active material in the present invention is about 130 to 160 F/g, a capacity to a voltage change corresponding to a capacitance of graphite is 390 to 1900 F/g. In this embodiment, it is, therefore, preferable to select a material which gives a capacitance of 390 F/g or more when being intercalated as graphite. In particular, a capacitance of 390 F/g or more is preferably expressed within the range of 1.8 V to 3 V during charging. Particularly preferably, it is 450 to 1300 F/g. For a common graphite, it is generally 2000 F/g or less and generally about 1600 F/g is sufficiently practical.

Next, a potential of the negative electrode side is determined to define a charging voltage. As described above, when a potential of a negative electrode is excessively reduced, in other words, excessive charging, reductive decomposition of a solvent occurs in the negative electrode side. When charge/discharge in an electric storage device of the present invention is observed with a three-electrode cell having a reference electrode, it is indicated that most of a charging voltage change is a potential change in the negative electrode side and as described above, a potential change in the positive electrode is small. This is because a reaction capacity associated with intercalation in the positive electrode graphite is significantly larger than an adsorption capacitance of active charcoal used for the negative electrode. When the capacitance is defined as a rate of change in a capacity per a unit voltage change, the results of a charge/discharge test using a three-electrode cell demonstrate that a capacitance of the positive electrode active material is considerably larger than that of the negative electrode active material.

Thus, when a positive electrode capacitance, a solvent decomposition potential in a positive electrode and a potential initiating intercalation are represented by Fc, Pc and Pt, respectively, all of these values have been determined by a charge/discharge test and a three-electrode charge/discharge test of a lithium counter-electrode. Furthermore, when a capacitance of active charcoal as a negative electrode material and a solvent decomposition potential in a negative electrode are represented by Fa and Pa, respectively, these values are known. Here, when a charging voltage in an electric storage device of the present invention is 3.2 V and a change in a positive electrode voltage per a unit weight due to intercalation during charging is Vc, a change in a negative electrode voltage, Va, is expressed as follows:

Va=Fc×Vc/Fa

Vc<Pc−Pt (1)

Vc+Pt−Pa<3.2 (2)

Since Vc must simultaneously satisfy the relations (1) and (2), Vc is determined such that these are satisfied.

After determining Vc, a required capacity Fc×Vc of the positive electrode material is determined because Fc is preferably 390 F/g as described above, and thus a capacity Fa×Va of the negative electrode material which is equal to the value can be determined. In an actual device, a capacity and a charging potential of a positive electrode are determined from a capacity and a charging voltage of a negative electrode determined as described above. Although, herein, Wc=Wa in terms of a weight of a positive electrode Wc and a weight of a negative electrode Wa, a capacity may be balanced between the positive and the negative electrodes by changing a weight ratio to some extent.

By such a design, a positive electrode and a negative electrode can be well balanced and while maintaining a positive electrode capacity at about 47 mAh/g or less and 31 mAh/g or more, a potential of a positive electrode during charging can be controlled within a predetermined range, for example, a charging voltage can be controlled to be 3.2 V or less. As a result, the device can operate with an interlayer distance of a graphitic material within the range of 0.434 nm or less and 0.337 nm or more on a full charge.

### Description of Materials

There will be described specific materials used for an electric storage device of the present invention. An electric storage device of the present invention has materials such as a positive electrode active material, a negative electrode active material, a binder, a conductive material, a collector, a separator and an electrolyte. The electric storage device may have a form such as winding, stack and meander (i.e. zigzag) types. As a system for taking an electric capacity, any of the conventional techniques such as ECaSS™ can be suitably applied.

The term, a “graphite” as used herein refers to a material having a basic structural unit (crystallite) of regular lamination of a two-dimensional lattice structure where carbon atoms form a hexagonal network plane based on a SP2 hybridized orbital and exhibiting strong anisotropy. A graphitic material is a material where graphite properties are adequately developed to be generally appreciated as a “graphite”, and herein includes graphite.

In the present invention, a carbon material is used as an active material for both positive and negative electrodes. As a positive active material, a material exhibiting a two-step sequential process as described above may be a graphitic material. A graphitic material used as a positive active material may be any of natural and artificial graphites, desirably a high crystallinity graphite for obtaining a higher capacity. For achieving satisfactory intercalation, a d(002) interlayer distance of the graphitic material is preferably 0.340 nm or less, more preferably 0.339 nm or less. A d(002) interlayer distance of the graphitic material is preferably 0.335 nm or more. In general, the material is preferably free from boron.

Particularly, in a particular embodiment where cycle properties are improved, an interlayer distance of the graphitic material is preferably 0.336 nm or less, more preferably 0.3355 nm or less for achieving particularly satisfactory intercalation.

Crystal structures for a graphitic material include a hexagonal crystal structure (ABAB . . . lamination periodicity) and a rhombohedron structure (ABCABC . . . lamination periodicity). In most cases, a rhombohedron structure is introduced by grinding, but for achieving a high capacity by intercalation, the material is preferably graphite without a rhombohedron structure.

For rapid intercalation, a larger outer surface area of a graphitic material particle is better (that is, a smaller graphite particle is better), but grinding often leads to introduction of a rhombohedron structure and thus deterioration in crystallinity of the graphitic material. An average particle size of the graphitic material is, therefore, 3 to 40 μm, more preferably 6 to 25 μm.

In terms of a specific surface area of a graphitic material, the graphitic material can be ground without introducing a rhombohedron structure while maintaining crystallinity of the graphitic material, by using, for example, a jet mill, to adjust a specific surface area to 1 to 20 m²/g, but for reducing a rate of decomposition of a solvent in the positive electrode surface, it is preferably 10 m²/g or less, more preferably 2 to 5 m²/g.

Furthermore, for increasing an electric storage capacity per a unit volume of an electric storage device, it may be effective to perform press-densification treatment (compaction treatment) of a graphitic material or to remove fine particles from a graphitic material. The press-densified graphite preferably has a tap density of 0.8 to 1.4 g/cc and a true density of 2.22 g/cc or more. Alternatively, a content of the graphitic material substantially having a size of 1 μm or less can be adjusted to 10% or less, to reduce decrease of a bulk density of the graphite and to inhibit increase of a surface area.

A carbon material used as a negative active material is preferably selected from materials in which ion adsorption exclusively occurs during charge/discharge, that is, intercalation does not occur; for example, active charcoal or a graphitic material. It is preferably a material having a larger specific surface area than a positive active material. When using a graphitic material, it is preferably different from that for a positive active material, particularly a material having a larger specific surface area than a graphitic material used for a positive electrode. Active charcoal may be a known active charcoal for a capacitor. Examples may include a chemically activated coconut husk active charcoal, a steam-activated coconut husk active charcoal, a phenol resin active charcoal and a pitch active charcoal, and an alkali-activated phenol resin active charcoal and a mesophase pitch active charcoal. In addition to common active charcoals, there can be used a high surface-area graphitic material, a CVD-processed active charcoal, a graphitic material or the like. A carbon material used as a negative active material preferably has a specific surface area of 300 m²/g or more, particularly preferably a high surface area of 450 m²/g to 2000 m²/g. In general, it is preferable to use active charcoal as a negative electrode active material, but for increasing an electric storage capacity density per a unit volume, a high surface-area graphitic material is suitable because it can be press-densified to increase a bulk density.

A binder may be, but not limited to, PVDF, PTFE, polyethylene, rubbers and the like.

Examples of a rubber binder component include aliphatic-based rubbers such as EPT, EPDM, butyl rubbers, propylene rubbers and natural rubbers, and aromatic-containing rubbers such as styrene-butadiene rubbers. The structures of these rubbers may have a hetero-containing moiety such as nitrile, acryl and carbonyl, or silicon, and may have straight and branched chains without limitations. These may be used alone or in combination of two or more, to be an excellent binder.

Furthermore, a conductive material such as carbon black and Ketjen Black may be, if necessary, added.

Although a current collector may be generally a pure aluminum foil, it may be pure aluminum or aluminum containing a metal such as copper, manganese, silicon, magnesium and zinc alone or in combination of two or more. Likewise, a stainless steel, nickel, titanium and the like may be used. Mixtures of these or those containing other elements can be used for enhancing conductivity and ensuring strength. The surface of the base material may be made uneven by, for example, etching, or a conductive metal or carbon may be embedded in or coat a base material. The current collector may be a foil or a mesh structure.

A separator may be, in addition to a cellulose paper and a glass fiber paper, a fine porous film or a laminated multilayer film made of polyethylene terephthalate, polyethylene, polypropylene and/or polyimide. Alternatively, a separator surface may be coated with PVDF, a silicon resin or a rubber resin, or metal oxide particles such as aluminum oxide, silicon dioxide and magnesium oxide may be embedded. Of course, one or more sheets of the separator may be placed between the positive and the negative electrodes, or two or more types of separators may be appropriately used.

Examples of an organic solvent which may be used as an electrolyte include cyclic carbonates such as propylene carbonate; cyclic esters such as γ-butyrolactone; heterocyclic compounds such as N-methylpyrrolidone; nitriles such as acetonitrile; and other polar solvents such as sulfolane and sulfoxides.

Specific compounds are as follows; ethylene carbonate, propylene carbonate, butylene carbonate, γ-butyrolactone, δ-valerolactone, N-methylpyrrolidone, N,N-dimethylimidazolidinone, N-methyloxazolidinone, acetonitrile, methoxyacetonitrile, 3-methoxypropionitrile, glutaronitrile, adiponitrile, sulfolane, 3-methylsulfolane, dimethylsulfoxide, N,N-dimethylformamide and trimethylphosphate.

These solvents may be used alone or in combination of two or more.

Preferable examples of electrolyte contained in the non-aqueous electrolyte include onium salts such as ammonium salts, pyridinium salts, pyrrolidinium salts, piperidinium salts, imidazolium salts and phosphonium salts, and preferable examples of anions of these salts include those derived from fluoro compounds such as fluoroborate ion (BF₄_{^{−}}), hexafluorophosphonate ion (PF₆_{^{−}}) and trifluoromethanesulfonate ion.

Specific examples are as follows; tetramethylammonium fluoroborate, ethyltrimethylammonium fluoroborate, diethyldimethylammonium fluoroborate, triethylmethylammonium fluoroborate, tetraethylammonium fluoroborate, tetrapropylammonium fluoroborate, tributylmethylammonium fluoroborate, tetrabutylammonium fluoroborate, tetrahexylammonium fluoroborate, propyltrimethylammonium fluoroborate, butyltrimethylammonium fluoroborate, heptyltrimethylammonium fluoroborate, (4-pentenyl)trimethylammonium fluoroborate, tetradecyltrimethylammonium fluoroborate, hexadecyltrimethylammonium fluoroborate, heptadecyltrimethylammonium fluoroborate, octadecyltrimethylammonium fluoroborate, 1,1′-difluoro-2,2′-bipyridinium bistetrafluoroborate, N,N-dimethylpyrrolidinium fluoroborate, N-ethyl-N-methylpyrrolidinium fluoroborate, N,N-diethylpyrrolidinium fluoroborate, N,N-dimethylpiperidinium fluoroborate, N-ethyl-N-methylpiperidinium fluoroborate, N,N-diethylpiperidinium fluoroborate, 1,1-tetramethylenepyrrolidinium fluoroborate, 1,1-pentamethylenepiperidinium fluoroborate, N-ethyl-N-methylmorpholinium fluoroborate, ammonium fluoroborate, tetraethylphosphonium fluoroborate, tetraethylphosphonium fluoroborate, tetrapropylphosphonium fluoroborate, tetrabutylphosphonium fluoroborate, tetramethylammonium hexafluorophosphate, ethyltrimethylammonium hexafluorophosphate, tetraethylammonium hexafluorophosphate, vinyltrimethylammonium hexafluorophosphate, hexadecyltrimethylammonium hexafluorophosphate, dodecyltriethylammonium hexafluorophosphate, tetraethylammonium perchlorate, tetraethylammonium hexafluoroarsenate, tetraethylammonium hexafluoroantimonate, tetraethylammonium trifluoromethanesulfonate, tetraethylammonium nonafluorobutanesulfonate, tetraethylammonium bis(trifluoromethanesulfonyl)imide, tetraethylammonium triethylmethylborate, tetraethylammonium tetraethylborate, tetraethylammonium tetrabutylborate, tetraethylammonium tetraphenylborate, 1-ethyl-3-methylimidazolium hexafluorophosphate, 1-ethyl-3-methylimidazolium fluoroborate, 1-ethyl-3-methylimidazolium trifluoromethanesulfonate, 1-butyl-3-methylimidazolium hexafluorophosphate, 1-butyl-3-methylimidazolium fluoroborate, 1-butyl-3-methylimidazolium trifluoromethanesulfonate, 1-hexyl-3-methylimidazolium hexafluorophosphate, 1-hexyl-3-methylimidazolium fluoroborate, 1-hexyl-3-methylimidazolium trifluoromethanesulfonate, 1-octyl-3-methylimidazolium hexafluorophosphate, 1-octyl-3-methylimidazolium fluoroborate, 1-butyl-2,3-dimethylimidazolium fluoroborate, 1-butyl-2,3-dimethylimidazolium trifluoromethanesulfonate, 1-hexyl-2,3-dimethylimidazolium fluoroborate, 1-hexyl-2,3-dimethylimidazolium trifluoromethanesulfonate, 1-butylpyridinium hexafluorophosphate, 1-butylpyridinium fluoroborate, 1-butylpyridinium trifluoromethanesulfonate, 1-hexylpyridinium hexafluorophosphate, 1-hexylpyridinium fluoroborate, 1-hexylpyridinium trifluoromethanesulfonate, 1-butyl-4-methylpyridinium hexafluorophosphate, 1-butyl-4-methylpyridinium fluoroborate, 1-fluoropyridiniumpyridine heptafluorodiborate and 1-fluoropyridinium fluoroborate. These electrolytes may be used alone or in combination of two or more.

### EXAMPLES

There will be described Examples of the present invention. These examples are intended to illustrate the invention and are not to be construed to limit the present invention.

### Example 1

Eighty four parts of a graphite, Timrex® SFG44 (from TIMCAL Ltd.; d(002) interlayer distance: 0.3354 nm, average particle size: 24 μm, surface area: 5 m²/g) free from a rhombohedron structure as a positive electrode active material was powder-blended with 8 parts of acetylene black (from Denki Kagaku Kogyo Kabushiki Kaisha), and to the mixture was added a solution of 8 parts of PVDF (from Kureha Chemical Industry Co., Ltd.) in NMP to prepare a slurry, which was then applied to an aluminum foil to form an electrode with a thickness of 100 μm. Eighty four parts of an active charcoal, RP-20 (from Kuraray Chemical Co., Ltd.; average particle size: 2 μm, surface area: 1800 m²/g) as a negative electrode active material was powder-blended with 8 parts of acetylene black, and to the mixture was added an NMP solution of 8 parts of PVDF to prepare a slurry, which was then applied to an aluminum foil to form an electrode with a thickness of 100 μm.

A ratio of weight per unit area of these electrodes after drying, that is, positive electrode active material/negative electrode active material, was 1/1. Each electrode was cut into a 4 cm² piece, and in the dry air, these electrodes were placed in an aluminum laminate bag such that their coating surfaces face each other via a Whatmann glass filter, and a 1.5 mol/L solution of TEMA.BF₄ salt (triethylmethylammonium tetrafluoroborate) in PC was injected and then these electrodes were pressed from the outside of the aluminum laminate bag to prepare a device.

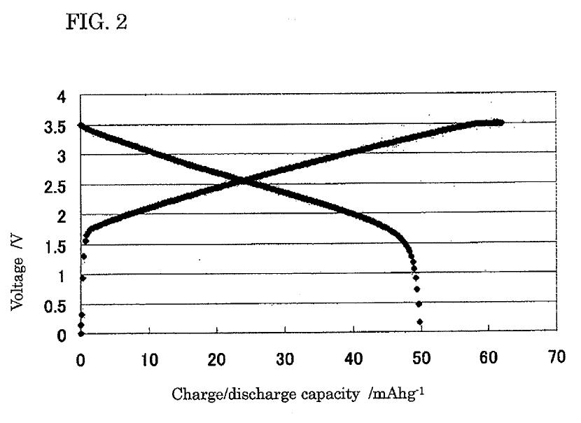

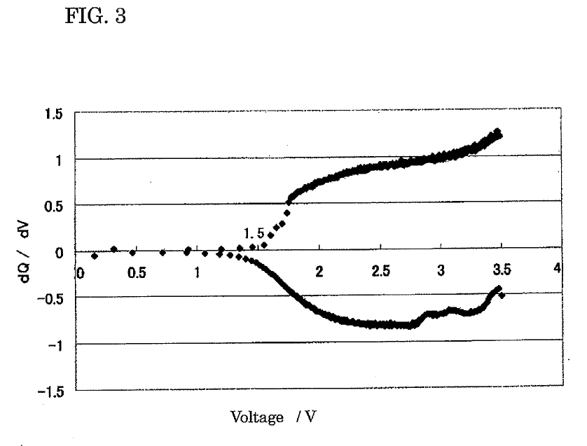

FIG. 2 shows a relationship between a charge/discharge capacity and a voltage, where the charge/discharge capacity was measured by chronopotentiometry. Until 1.75 V, a charging capacity was as small as 1.5 mAh/g, which is a capacity derived from electrolyte cation adsorption in the negative electrode and electrolyte anion adsorption in the positive electrode. A large charging capacity of 61.5 mAh/g was observed over 1.75 V. A discharge capacity of the positive electrode active material on a weight basis was 49.8 mAh/g, and an initial charge/discharge efficiency was 79%. A discharge capacity from 3.5 V to 1.5 V was 98% of the total discharge capacity. A dQ/dV was calculated by dividing a capacity variation by a voltage variation for studying the electrochemical properties of the device corresponding to cyclic voltammetry. The results are shown in FIG. 3. When the device was charged until 3.5 V, a current was observed as a shoulder at 1.75 V where rapid change from adsorption to intercalation occurred, and then a reaction current showing a large charging capacity (in the high-voltage range) was observed.

For investigating the cause of generation of charge/discharge capacity in the device, a relationship between a graphite structure and a voltage was studied. After preparing a device as described above except that a polyethylene bag was used, the device was charged at 1 mA until 3.5 V, and after reaching a predetermined voltage, a 002 diffraction line of graphite as an positive electrode active material of the device was determined in situ using a XRD apparatus (from Rigaku Corporation) over the polyethylene bag. The measurement was conducted under the conditions; lamp: Cu, output: 50 kV-150 mA, scan rate: 10°/min, slit: 0.5°-0.15 mm-0.5°, monochromation: curved monochromator.

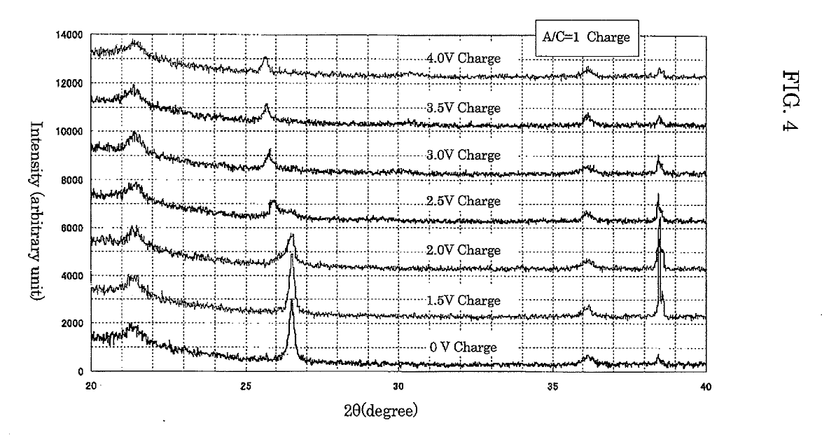

FIG. 4 shows a relationship between a charging voltage and a graphite X-ray diffraction pattern and FIG. 5 shows a relationship between a discharge voltage and a graphite X-ray diffraction pattern. In the charging in FIG. 4, at 2 V, a graphite 002 diffraction peak gave a new diffraction line in a lower angle side than the position of 26.5° before charging, and as a charging voltage is increased, an intensity of the diffraction line in the lower angle side was increased and the peak of the diffraction line further shifted to the lower angle side. After a charging voltage exceeded 2.5 V, a diffraction line at 26.5° disappears. In the discharge in FIG. 5, a completely opposite phenomenon was observed, that is, as a voltage is reduced due to discharge, a graphite 002 diffraction peak shifts to the high angle side and a graphite 002 diffraction peak after discharging appears at 26.5° which is the same position as the diffraction line before charging. Thus, it is shown that during charging, a graphite interlayer distance increases and during discharging, it reversibly returns to the original interlayer distance. Such variation in a graphite interlayer distance associated with charge/discharge indicates intercalation of anions into a graphite interlayer distance.

### Example 2

Eighty four parts of natural graphite (from Nippon Graphite Fiber Corporation; d(002) interlayer distance: 0.3364 nm, average particle size: 20.0 μm, surface area: 3.4 m²/g) free from a rhombohedron structure as a positive electrode active material was powder-blended with 8 parts of acetylene black (from Denki Kagaku Kogyo Kabushiki Kaisha), and to the mixture was added a solution of 8 parts of PVDF (from Kureha Chemical Industry Co., Ltd.) in NMP to prepare a slurry, which was then applied to an aluminum foil to form an electrode with a thickness of 100 μm. Ninety five parts of an active charcoal, SP-450 (from Nippon Graphite Industries, Ltd.; d(002) interlayer distance: 3.371 nm, average particle size: 1.5 μm, surface area: 403 m²/g) as a negative electrode active material was powder-blended with 8 parts of acetylene black (from Denki Kagaku Kogyo Kabushiki Kaisha), and to the mixture were added one part of CMC2270 (from Daicel Chemical Industries, Ltd.) and 4 parts of PTFE (from DuPont-Mitsui Fluorochemicals) to prepare a slurry, which was then applied to an aluminum foil to form an electrode with a different thickness.

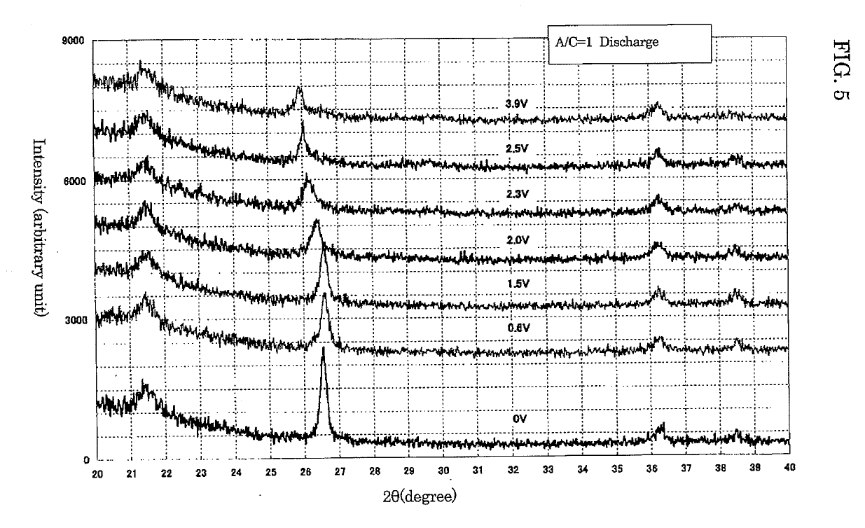

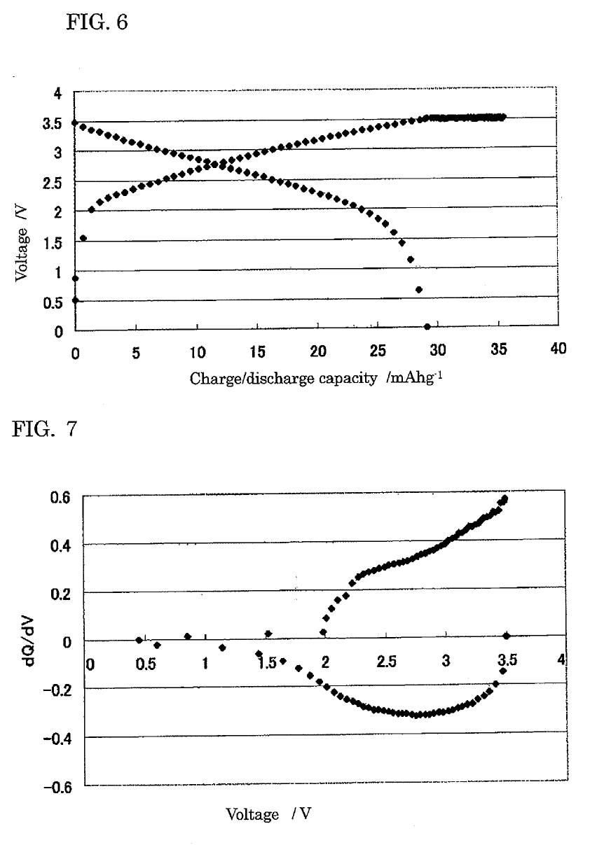

Each electrode was cut into a 4 cm² piece, and in the dry air, these electrodes were placed in a polyethylene bag such that their coating surfaces face each other via a Whatmann glass filter, and a 1.5 mol/L solution of TEMA.PF₆ salt in PC was injected and then these electrodes were pressed from the outside of the polyethylene bag to prepare a device, in which a weight ratio of the positive electrode active material/the negative electrode active material=1/1.2. FIGS. 6 and 7 show the results of charge/discharge capacity measurement as described in Example 1. A discharge capacity of the positive electrode on a weight basis was 36.3 mAh/g and a discharge capacity at 1.5 V or higher was 34.1 mAh/g, which was 94% of the total discharge capacity. There is again observed shift of a diffraction angle to a lower angle side due to anion intercalation at 2 V or higher, that is, increase in an interlayer distance.

### Reference Example

Eighty four parts of a graphite, Timrex® KS6 (containing a rhombohedron structure, from TIMCAL Ltd.; d(002) interlayer distance: 0.3357 nm, average particle size: 24 μm, surface area: 20 m²/g) was powder-blended with 8 parts of acetylene black (from Denki Kagaku Kogyo Kabushiki Kaisha), and to the mixture was added an NMP solution of 8 parts of PVDF (from Kureha Chemical Industry Co., Ltd.) to prepare a slurry, which was then applied to an aluminum foil to form an electrode with a thickness of 100 μm. Eighty four parts of an active charcoal, RP-20 (from Kuraray Chemical Co., Ltd.; average particle size: 2 μm, surface area: 1800 m²/g) as a negative electrode active material was powder-blended with 8 parts of acetylene black, and to the mixture was added a solution of 8 parts of PVDF in NMP to prepare a slurry, which was then applied to an aluminum foil to form an electrode with a thickness of 100 μm.

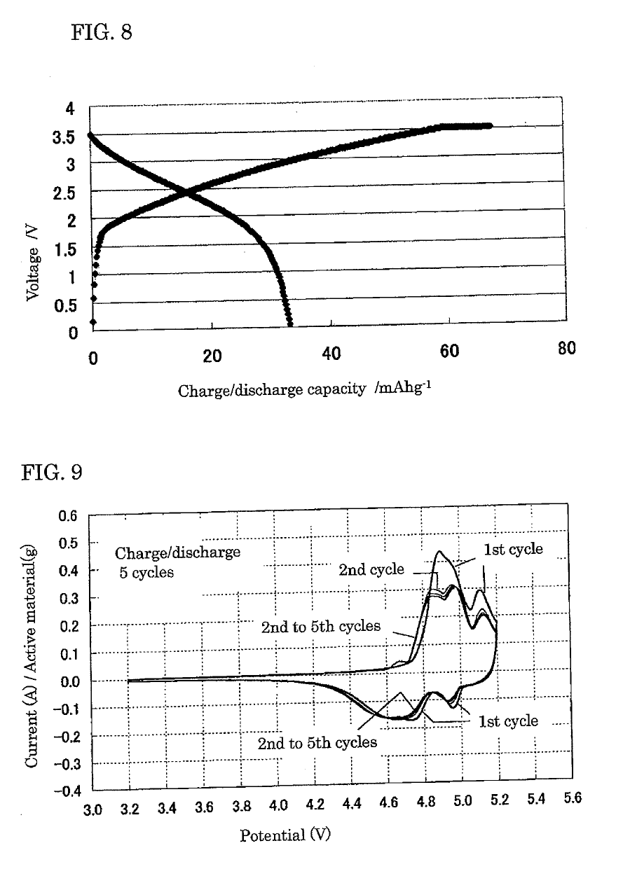

Each electrode was cut into a 4 cm² piece, and in the dry air, these electrodes were placed in a polyethylene bag such that their coating surfaces face each other via a Whatmann glass filter, and a 1.5 mol/L solution of TEMA.PF₆ salt (triethylmethylammonium hexafluorophosphate) in PC was injected and then these electrodes were pressed from the outside of the polyethylene bag to prepare a device, in which a weight ratio of the positive electrode active material/the negative electrode active material=1/1.2. FIG. 8 shows the results of charge/discharge capacity measurement as described in Example 1. A discharge capacity of the positive electrode on a weight basis was 33.3 mAh/g and a discharge capacity at 1.5 V or higher was 28.8 mAh/g, which was 86.5% of the total discharge capacity. An initial charge/discharge efficiency was 42.6%. There is again observed shift of a diffraction angle to a lower angle side due to anion intercalation at 1.75 V or higher, that is, increase in an interlayer distance.

### Example 3

Eighty four parts of a graphite, Timrex® KS6 (from TIMCAL Ltd.; d(002) interlayer distance: 0.3357 nm, average particle size: 3.4 μm, surface area: 20 m²/g) as a positive electrode active material was powder-blended with 8 parts of acetylene black (from Denki Kagaku Kogyo Kabushiki Kaisha), and to the mixture was added a solution of 8 parts of PVDF (from Kureha Chemical Industry Co., Ltd.) in NMP to prepare a slurry, which was then applied to an aluminum foil to form an electrode with a thickness of 100 μm.

Using metal lithium as a negative electrode and a graphite electrode as a positive electrode, a glass filter was set as a separator and an a 1.5 mol/L solution of LiBF₄ salt (lithium tetrafluoroborate) in PC was injected to assemble a device (half cell). This device was subjected to charge/discharge by CV (cyclic voltammetry) with a voltage of 0 V to 6 V with reference to Li_{⁺}/Li.

FIG. 9 shows the results of charge/discharge until 5.2 V (with reference to an Li_{⁺}/Li potential) by cyclic voltammetry. FIG. 9 indicates a small capacity reduction, but does not indicate a large reaction current such as solvent decomposition which may cause cycle deterioration. The device in a charge state at 5.2 V (with reference to an Li_{⁺}/Li potential) was disassembled under an argon atmosphere to take out the positive electrode, which was then washed with anhydrous dimethyl carbonate; then the electrode surface was coated with liquid paraffin and the electrode was inserted into a polyethylene bag which was then closed. Then the positive electrode graphite was analyzed by XRD over the polyethylene bag using a XRD apparatus (from Rigaku Corporation). The XRD analysis was conducted under the conditions; lamp: Cu, output: 50 kV-150 mA, scan rate: 10°/min, slit: 0.5°-0.15 mm-0.5°, monochromation: curved monochromator.

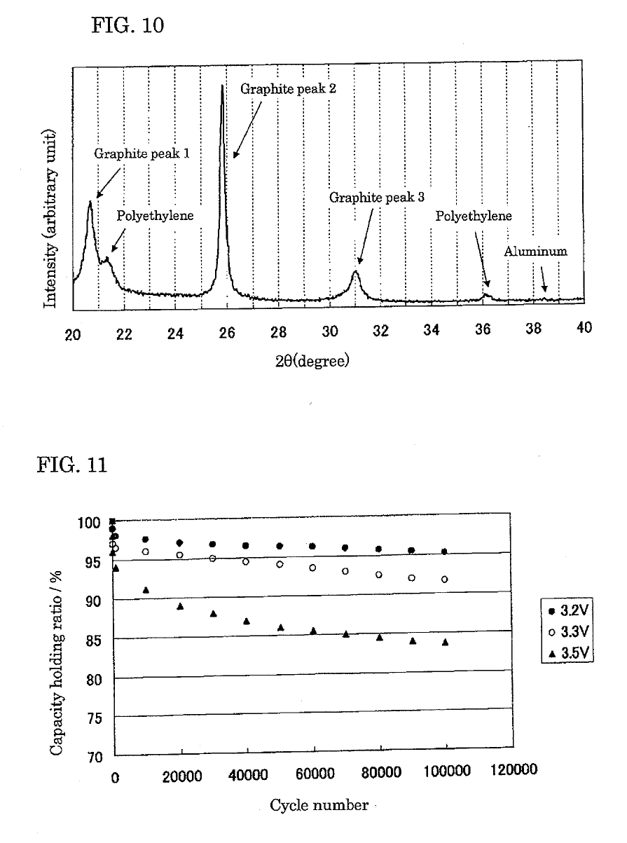

FIG. 10 shows a XRD profile of a charged graphite. Peak 1 in FIG. 10 corresponds to an intercalation compound of graphite and BF₄_{^{−}} in stage 4, in which an interlayer distance is 0.4293 nm. Peak 2 corresponds to the intercalation compound in stage 5, in which an interlayer distance is 0.3447 nm. Peak 3 is a secondary diffraction line peak of peak 2. These results indicate that the positive electrode graphite in the charge state at 5.2 V (with reference to an Li_{⁺}/Li potential) forms mainly an intercalation compound in stage 4 and an intercalation compound in stage 5 with BF₄_{^{−}} anion.

### Example 4

Eighty four parts of an active charcoal RP-20 (from Kuraray Chemical Co., Ltd., average particle size: 2 μm, surface area: 1800 m²/g) as a negative electrode active material was powder-blended with 8 parts of acetylene black, and then to the mixture was added a solution of 8 parts of PVDF in NMP to prepare a slurry, which was then applied to an aluminum foil to form a negative electrode with a thickness of 100 μm. It was combined with the positive electrode prepared in Example 1 and furthermore with a separator and an electrolyte as described in Example 1, to prepare a three-electrode electric storage device with ratio of weight per unit area of positive electrode/negative electrode of 1/1 and having lithium metal with an electrode area of 2 cm² as a reference electrode. Charge/discharge was conducted at different charging voltage of 3.2 V, 3.3 V and 3.5 V and observed initial positive electrode potentials were 5.13 V (with reference to an Li_{⁺}/Li potential), 5.18 V (with reference to an Li_{⁺}/Li potential) and 5.267 V (with reference to an Li_{⁺}/Li potential), respectively. Discharge capacities on basis of the positive electrode were 42.8 mAh/g, 44.7 mAh/g and 47.0 mAh/g.

To this three-electrode cell were set the positive and the negative electrodes described above, and using an Ag/AgCl/saturated KCl electrode as a reference electrode, a cycle test of 100,000 cycles was conducted. A charge/discharge current was 20 mA/cm² and a discharge voltage was cut at 2.0 V. The results are shown in FIG. 11. FIG. 11 indicate that cycle properties are satisfactory at a charging voltage of 3.2 V while cycle deterioration occurs at a charging voltage of 3.5 V.

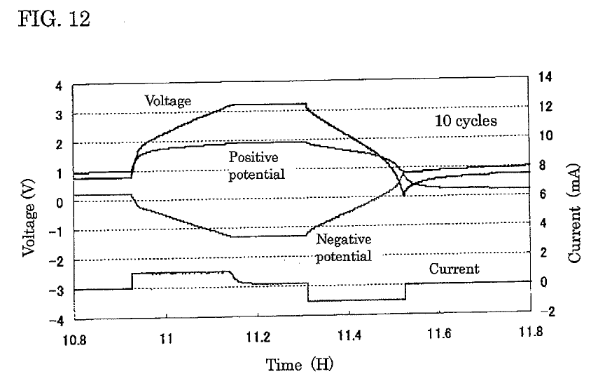

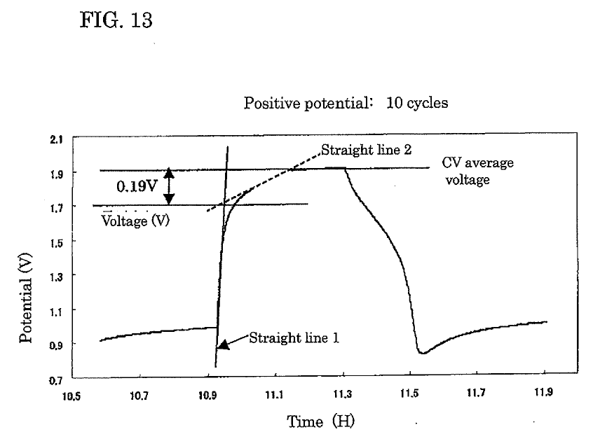

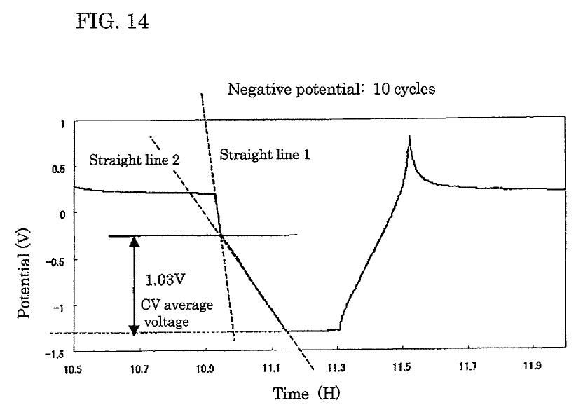

Similarly, to the above three-electrode cell were set the positive and the negative electrodes described above and using an Ag/AgCl/KCl reference electrode, a charge/discharge test was conducted. FIG. 12 shows a charge/discharge curve at 10th cycle. FIGS. 13 and 14 are enlarged voltage variations in the positive and the negative electrodes, respectively. From these figures, a voltage variation between 1.8 V and 3.2 V was calculated for the positive and the electrode electrodes, and monopolar capacitance ratios of the positive and the negative electrode were calculated. As a result, the relation:

(positive electrode capacitance)/(negative electrode capacitance)=(voltage variation in a negative electrode)/(voltage variation in a positive electrode)

was indicated, and the following value was calculated:

(positive electrode capacitance)/(negative electrode capacitance)=1.03/0.19=5.42.

Since a monopolar capacity calculated from a capacitance between 1.8 V and 2.3 V was 145 F/g for a capacitor prepared using an active charcoal in this invention for both positive and negative electrodes, a capacitance of the positive electrode can be estimated to be 785 F/g. If a capacitance of the graphite used as a positive active material is based on a surface area, a capacitance is about 7.5×μ(F/cm², and, therefore, a surface area of the graphite can be estimated to be about 10450 m²/g. However, the graphite has a surface area of 20 m²/g. It can be, therefore, concluded that a capacitance of graphite is derived from a factor other than a surface area, that is, intercalation.

### INDUSTRIAL APPLICABILITY

An electric storage device of the present invention can be used as an alternative to a conventional lead battery, lithium-ion secondary battery, nickel-metal-hydride secondary battery, electric double layer capacitor or the like.

1. An electric storage device comprising carbonaceous active material-containing positive electrode and negative electrode, an onium salt-containing nonaqueous electrolyte, and a separator,
wherein an electrochemical charge process in the positive electrode shows a two-step sequential charge process having a threshold of a transition voltage and consisting of an adsorption process of anions of the onium salt in a lower voltage range than the transition voltage and an intercalation process of anions of the onium salt in a higher voltage range than the transition voltage.

2. The electric storage device according to claim 1, wherein only a voltage range where anions of the onium salt intercalate is used as a charge/discharge range during operation.

3. The electric storage device according to claim 1, wherein the transition voltage is set within the range of 1.5 to 2.5 V.

4. The electric storage device according to claim 1, wherein the positive active material is a graphitic material, and the negative active material is a carbonaceous material having a larger specific surface area than that of the graphitic material used as the positive active material.

5. The electric storage device according to claim 4, wherein the graphitic material used as the positive active material has a d(002) interlayer distance of 0.340 nm or less and a specific surface area of less than 10 m²/g.

6. The electric storage device according to claim 5, wherein the graphitic material used as the positive active material does not comprise a rhombohedron structure.

7. The electric storage device according claim 1, wherein anions of the onium salt contain at least one of PF₆_{^{−}} and BF₄_{^{−}}.

8. An electric storage system comprising the electric storage device according to claim 1, using only a voltage range where anions of the onium salt intercalate.

9. The electric storage system according to claim 8, comprising a voltage controlling mechanism which controls a voltage during operation within only a voltage range where anions of the onium salt intercalate.

10. An electric storage system comprising the electric storage device according to claim 1, wherein the positive active material is a graphitic material, and during charging in the operation as an electric storage device, a charging voltage is controlled such that a positive electrode capacity is within the range of 47 mAh/g to 31 mAh/g and an interlayer distance in the graphitic material is within the range of 0.434 nm to 0.337 nm.

11. An electric storage system, according to claim 10, wherein in the operation as an electric storage device, a positive electrode potential to a Li+/Li electrode during charging is controlled to be 5.2 V or less.

12. An electric storage system, according to claim 10, wherein in the operation as an electric storage device, the system is used with a charging voltage of 3.2 V or less.

13. The electric storage system according to claim 10, wherein an interlayer distance of the graphitic material before charging is 0.336 nm or less.

14. The electric storage system according to claim 10, wherein in a charging curve between 1.8 V and 3 V, a capacitance of the graphitic material is 390 F/g or more.

15. An electronic device comprising the electric storage device according to claim 1.

16. A motive power system comprising the electric storage device according to claim 1.

17. A method for controlling a voltage initiating decomposition of the electrolyte in the electric storage device according to claim 1, wherein the decomposition initiating voltage is controlled by changing the transition voltage.

18. An electric storage system comprising the electric storage device according to claim 1, wherein in the operation as an electric storage device, a positive electrode potential to a Li+/Li electrode during charging is controlled to 5.2V or less.

19. An electric storage system comprising the electric storage device according to claim 1, wherein the operation as an electric storage device, the system is used with a charging voltage of 3.2V or less.
